(19) United States
(12) Patent Application Publication
(10) Pub. No.: US 2017/0105141 A1
(43) Pub. Date: Apr. 13, 2017

(54) METHOD FOR SHORTENING A DELAY IN REAL-TIME VOICE COMMUNICATION AND ELECTRONIC DEVICE

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventor: Rongquan XIAO, Tianjin (CN)

(21) Appl. No.: 15/239,081

(22) Filed: Aug. 17, 2016

Related U.S. Application Data
(63) Continuation of application No. PCT/CN2016/082225, filed on May 16, 2016.

(30) Foreign Application Priority Data
Oct. 8, 2015 (CN) 201510644497.5

(51) Int. Cl. H04W 28/06; H04L 12/26; H04W 24/08; H04W 28/14

(52) U.S. Cl. CPC H04W 28/06; H04W 28/14; H04L 43/16; H04W 24/08

(57) ABSTRACT

Embodiments of the disclosure provide a real-time voice receiving device, and a method for shortening a delay, in real-time voice communication. The method applicable to a real-time voice receiving device, the method includes: monitoring at least the amount of data in an input buffer area of the re-sampling module, wherein the data in the input buffer area of the re-sampling module are decompressed and de-packaged data; re-sampling the data in the input buffer area of the re-sampling module if the monitored amount of data in the buffer area reaches a re-sampling threshold: and performing a succeeding stage of processing on the re-sampled data. The data can be re-sampled to thereby decrease the amount of buffered data so that the audio data can be played by a voice receiving device at a higher speed for the purpose of shortening a delay.

This application is a continuation of International Application No. PCT/CN2016/082225, filed on May 16, 2016, which is based upon and claims priority to Chinese Patent Application No. 201510644497.5, filed with the Chinese Patent Office on Oct. 8, 2015 and entitled “A real-time voice receiving device, and a method for shortening a delay, in real-time voice communication”, the content of which is hereby incorporated by reference in its entirety.

### TECHNICAL FIELD

The present disclosure relates to the field of audios, and particularly to a method for shortening a delay in real-time voice communication, and an electronic device.

### BACKGROUND

As network technologies are being popularized and developed, and particularly the rate of network communication is growing, and the mobile Internet is flourishing, people today have increasingly accessed products and services based upon real-time voice communication, e.g., network phoning, instant voice communication, an intelligent home video intercom system, etc. In this interaction process, it is of great importance for voice to reach from one end to the other end timely because real-time voice will be possible only if there is a short delay of voice in communication. However in existing real-time voice communication, a delay may be initially short but will become so large over time that the delay may he up to several seconds and even tens of seconds.

The delay in real-time voice communication may be described taking a voice communication process illustrated in FIG. 1 as an example.

As illustrated in FIG. 1, audio data are collected, analog to digital-encoded, compressed, and packaged by a voice transmitter, and are transmitted to a voice receiver over a network, and then are de-packaged, decompressed, digital to analog-encoded, and played by the voice receiver to thereby play the voice.

Since there are different system reference clocks for the voice transmitter and the voice receiver, there may be an accumulative delay at the voice receiver. Additionally there may be a sudden delay of insertion due to limited resources. For example, if a CPU sudden reloads while the voice is being played by the audio receiver, then the audio data may be stopped temporally from being processed, thus resulting in a delay of insertion. Both the accumulative delay and the sudden delay of insertion appear to the voice receiver that there are more and more audio data being accumulated before they are fed to a digital to analog decoding module.

### SUMMARY

Embodiments of the disclosure provide a method for Shortening a delay in real-time voice communication, an electronic device and a storage medium so as to address the problem in the prior art of a delay of real-time voice communication being prolonged over time.

In one aspect, an embodiment of the disclosure provides a method for shortening a delay in real-time voice communication, applicable to a real-time voice receiving device, the method including:

monitoring at least the amount of data in an input buffer area of a re-sampling module, wherein the data in the input buffer area of the re-sampling module are decompressed and de-packaged data;

re-sampling the data in the input buffer area of the re-sampling module if the monitored amount of data in the buffer area reaches a re-sampling threshold; and

performing a succeeding stage of processing ors the re-sampled data.

In another aspect, an embodiment of the disclosure provides an electronic device including:

at least one processor; and

a memory communicably connected with the at least one processor for storing instructions executable by the at least one processor, wherein execution of the instructions by the at least one processor causes the at least one processor to:

monitor at least the amount of data in an input buffer area of a re-sampling module, wherein the data in the input buffer area of the re-sampling module are decompressed and de-packaged data;

re-sample the data in the input buffer area of the re-sampling module if the monitored amount of data in the buffer area reaches a re-sampling threshold; and

perform a succeeding stage of processing on the re-sampled data.

In another aspect, an embodiment of the disclosure provides a non-transitory computer-readable storage medium storing executable instructions that when executed by an electronic device, cause the electronic device to:

monitor at least the amount of data in an input buffer area of a re-sampling module, wherein the dais in the input buffer area of the re-sampling module are decompressed and de-packaged data;

re-sample the data in the-input buffer area of the re-sampling module if the monitored amount of data in the buffer area reaches a re-sampling threshold; and

perform a succeeding stage of processing or the re-sampled data.

### BRIEF DESCRIPTION OF THE DRAWINGS

In order to make the technical solutions according to the embodiments of the disclosure or m the prior art more apparent, the drawings to which a description of the embodiments or the prior art refers will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a flow chart of real-time voice communication in the prior-art;

FIG. 2 is a flow chart of a method for shortening a delay in real-time voice communication according to an embodiment of the disclosure;

FIG. 3 is a flow chart of a real-time voice communication method according to an embodiment of the disclosure;

FIG. 4 is a schematic diagram of an application scenario according to an embodiment of the disclosure;

FIG. 5 is a flow chart of real-time voice communication according to an embodiment of the disclosure;

FIG. 6 is another flow chart of real-time voice communication according to an embodiment of the disclosure;

FIG. 7 is a schematic diagram of a voice receiving device in real-time voice communication according to an embodiment of the disclosure; and

FIG. 8 is a schematic diagram of an electronic device according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

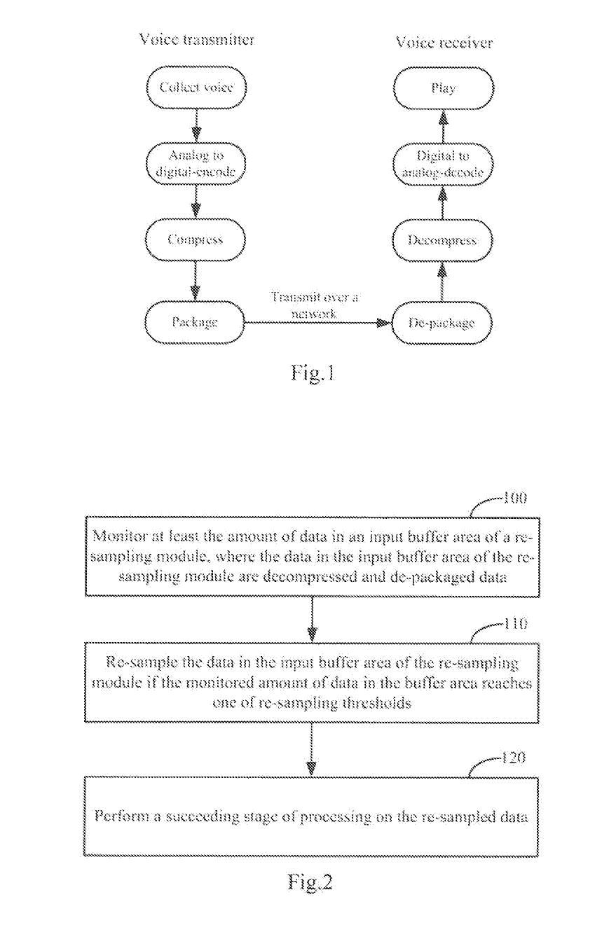

FIG. 2 illustrates a method for shortening a delay in real-time voice communication according to an embodiment of the disclosure, where the method particularly includes the following operations:

The step 100 is to monitor at least the amount of data in an input buffer area of a re-sampling module, where the data in the input buffer area of the re-sampling module are decompressed and de-packaged data.

Data as referred to in the embodiments of the disclosure are audio data.

In an embodiment of the disclosure, the step 100 can be performed by the re-sampling module, or can be performed by a monitoring module separately arranged, but the embodiment of the disclosure will not be limited thereto.

The step 110 is to re-sample the data in the input buffer area of the re-sampling module if the monitored amount of data in the buffer area reaches a re-sampling threshold.

The step 120 is to perform a succeeding stage of processing on the re-sampled data.

In the method for shortening a delay in real-time voice communication according to the embodiment of the disclosure, the decompressed and de-packaged data are stored in the input buffer area of-the re-sampling module, and at least the input buffer area of the re-sampling module is monitored so that if the monitored amount of data in the buffer area reaches the re-sampling threshold, then the data in the input buffer area of the re-sampling module may be re-sampled so that the succeeding stage of processing is performed on the re-sampled data instead of processing all the data. The data can be re-sampled to thereby decrease the amount of buffered data so that the audio data can be played by a voice receiving device at a higher speed for the purpose of shortening a delay.

In embodiments of the disclosure, the step 110 above can be performed by various ways. Optionally the data in the input buffer area of the re-sampling module are re-sampled by a re-sampling ratio corresponding to the preset re-sampling threshold, where each re-sampling threshold corresponds to at least one re-sampling ratio.

Here both the re-sampling threshold and the re-sampling ratio are preset, and more than one re-sampling threshold can be preset. For example, a group of re-sampling thresholds are preset, and accordingly a set of re-sampling ratios are preset, one of re-sampling ratios corresponds to one of the re-sampling thresholds.

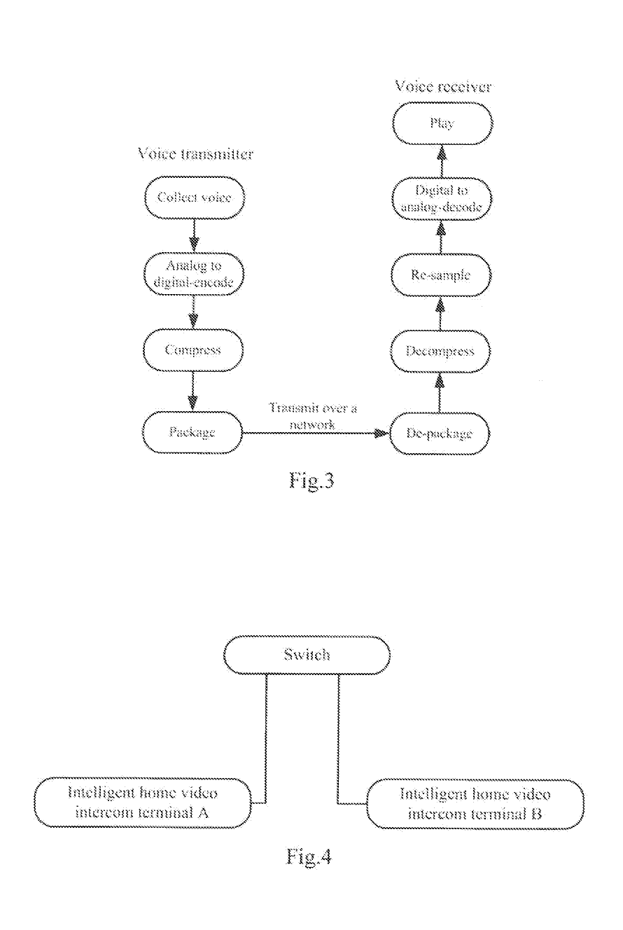

In an embodiment of the disclosure, the re-sampling module can be arranged at any processing stage after de-packaging and decompression. As a result, the audio data will be digital to analog-decoded and played no matter which operations are involved in a particular processing flow of the voice receiver. Preferably the re-sampling module is arranged at a preceding stage to a digital to analog decoding module, that is, a succeeding processing module to the re-sampling module is the digital to analog decoding module, to thereby shorten the relay as many as possible. For example, further to the voice communication flow illustrated in FIG. 1, the re-sampling module can be inserted after decompression and before digital to analog decoding as in a corresponding flow illustrated in FIG. 3.

No matter whichever succeeding stage of processing after re-sampling, all the data which have not entered the succeeding stage of processing shall he re-sampled as many as possible, that is, the data shall remain in buffer areas of the respective preceding modules to the re-sampling module as few as possible, which may require the input buffer area of the re-sampling module to be as large as possible. In an embodiment of the disclosure, the size of the input buffer area of the re-sampling module can be determined by audio processing parameters by the voice receiving device in current real-time voice communication.

Particularly if the audio processing parameters reflect the amount of data which can be processed per second by the voice receiving device in current parameters of audio processing, then the size of the input buffer area of the re-sampling module can be set to accommodate the amount of data processed in N seconds by the voice receiving device in current real-time voice communication, where the value of N can be determined empirically, e.g., 5 seconds. If the audio processing parameters are particularly a sampling rate of 16K, a single sound channel a bit rate of 16 bits, the value of N being 5 seconds, then the size of the input buffer area of the re-sampling module is 16/8*1*16000*5≈156 KB.

It shall be noted that the size of the input buffer area of the re-sampling module is adjustable. For example, if the audio processing parameters of the voice receiving device in current real-time voice communication are changed, then the size of the input buffer area of the re-sampling module may be adjusted adaptively.

Further to any one of the embodiments above of the method, only the amount of data in the input buffer area of the re-sampling module of the voice receiving device in current real-time voice communication can be monitored in the step 100, or both the amount of date in the input buffer area of the re-sampling module, and the amount of data in the input buffer area of the succeeding stage of processing module to the re-sampling module of the voice receiving device in current real-time voice communication can be monitored in the step 100.

Further to any one of the embodiments above of the method, the step 100 can be performed when a trigger condition is satisfied, or can be performed in real time in the voice communication process. If the step 100 is performed when the trigger condition is satisfied, then the embodiment of the disclosure will not be limited to any particular trigger condition. If the succeeding stage of processing module to the re-sampling module is the digital to analog-decoding module In a non-blocking mode, then the step 100 may be triggered under such a condition that the input buffer area of the digital to analog-decoding module is full. Accordingly the step 100 can be performed by determining that the input buffer area of the succeeding stage of processing module operating in a non-blocking mode is full, according to a full input butler area indicator of the succeeding stage of processing module, and monitoring at least the amount of data in the input buffer area of the re-sampling module of the voice receiving device in real-time voice communication.

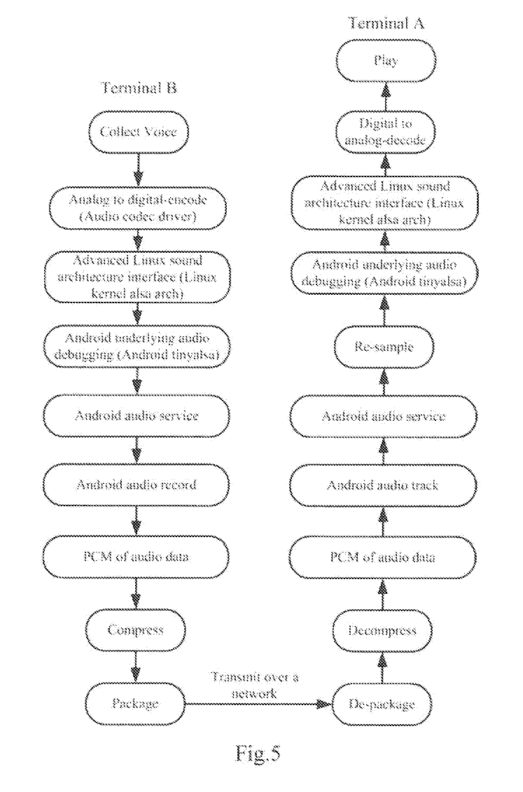

Taking an intelligent home scenario illustrated in FIG. 4 as an example, an intelligent home video intercom terminal A (a terminal A below for brevity) and an intelligent home video intercom terminal B (a terminal B below for brevity) are connected, respectively with a switch, and transmit audio data to each other through the switch to thereby enable real-time voice communication between the terminal A and the terminal B.

If a user A′ speaks through the terminal A, and a user B′ listens through the terminal B, then the terminal A is a voice transmitting device, and the terminal B is a voice receiving device; or If the user A′ listens through the terminal A, and the user B′ speaks through the terminal B, then the terminal A is a receiving voice device, and the terminal B is a voice transmitting device.

If an operating system of the terminal A is the Android system, then a software module of the terminal A which is used as a voice receiving device is written in the C++ language in this embodiment. Of course, the software module of the terminal A which is used as a voice receiving device can alternatively be written in the Java language.

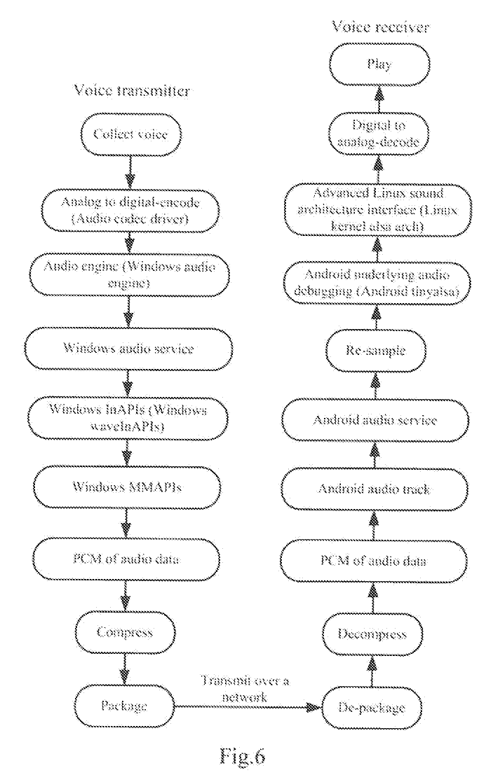

Then if an operating system of the terminal B is the Android system, and the terminal A is used as a voice receiving device, then their real-time voice communication flow may be as illustrated in FIG. 5, if the operating system of the terminal B is the Windows system, and the terminal A is used as a voice receiving device, then their real-time voice communication flow may be as Illustrated in FIG. 6.

The re-sampling module is arranged at a preceding stage to underlying audio debugging in the Android system in both FIG. 5 and FIG. 6. However in a real application, the re-sampling module can alternatively be arranged anywhere succeeding to PCM of the audio data and preceding to digital to analog-decoding.

In this embodiment, if the size of an output buffer area of an Android underlying audio debugging module (i.e., a succeeding stage of processing module to the re-sampling module) can store data, the amount of which is no more than 20 ms, and also the size of an output buffer area of an Android service module can store data, the amount of which is no more than 20 ms, then the longest underlying delay of buffer in the re-sampling module will be no longer than 40 ms, so the delay may not be considered for being adjusted.

In this embodiment, the size of the input buffer of the re-sampling module can store data, the amount of which is 5 s, and if an Android audio tracking module is invoked to write data in a non-blocking mode, then if an unexpected value is returned indicating that there is no sufficient buffer to have more data written therein, then the re-sampling module may start monitoring the amount of data in the input buffer area thereof, and if the amount of data is accumulated up to some threshold in Table 1 below, then the re-sampling module may re-sample the data in the input buffer area, thereof by a re-sampling ratio corresponding to the threshold.

TABLE 1

| The amount of data in the input buffer area of | Re-sampling ratio |
|---|---|
| the re-sampling module (in milliseconds (ms)) | (input vs. output) |
| ≧5000 | 100:76 |
| ≧4000 | 100:80 |
| ≧3000 | 100:84 |
| ≧2000 | 100:88 |
| ≧1000 | 100:92 |
| ≧500 | 100:96 |
| ≧200 | 100:99 |

Given the re-sampling ratio of 100:80, for example, the voice can be played at a speed raised by 20%.

Some of the re-sampled data may be lost, and if a dithering optimization process needs to be performed on gaps between the swapped data in an existing dithering optimization scheme, a repeated description of which will be omitted here.

In this embodiment, the functions of the re-sampling module can he performed through programming. It shall be noted that a chip capable of re-sampling can alternatively be built in the device.

Based upon the same inventive idea as the method, an embodiment of the disclosure further provides a real-time voice receiving device in real-time voice communication as illustrated in FIG. 7, which includes at least:

A re-sampling module 701 is configured to monitor at least the amount of data in an input buffer area of the re-sampling module, where the data in the input buffer area of the re-sampling module are decompressed and de-packaged data; and to re-sample the data in the input buffer area of the re-sampling module if the monitored amount of data in the buffer area reaches a re-sampling threshold; and

A succeeding stage of processing module 702 to the re-sampling module is configured to process the re-sampled data.

In the real-time voice receiving device in real-time voice communication according to the embodiment of the disclosure, the decompressed and de-packaged data are stored In the input buffer area of the re-sampling module, and at least the input buffer area of the re-sampling module is monitored so that if the monitored amount of data in the buffer area reaches the re-sampling threshold, then the data in the input buffer area of the re-sampling module may be re-sampled so that the succeeding stage of processing is performed on the re-sampled data instead of processing all the data. The data can be re-sampled to thereby decrease the amount of buffered data so that the audio data can be played by a voice receiving device at a higher speed for the purpose of shortening a delay.

Optionally the re-sampling module configured to re-sample the data in the input buffer area of the re-sampling module is configured:

To re-sample the data in the input buffer area of the re-sampling module by a re-sampling ratio preset corresponding to the re-sampling threshold, where each re-sampling threshold corresponds to at least one re-sampling ratio.

Optionally the re-sampling module configured to monitor the amount of data in the input buffer area of the re-sampling module is configured:

To monitor only the -amount of data in the input buffer area of the re-sampling module; or

To monitor both the amount of data in the input buffer area of the re-sampling module, and the amount of data in an input buffer area of a succeeding stage of processing module.

Further to any one of the embodiments above of the device, optionally the size of the input buffer area of the re-sampling module is determined by audio processing parameters of the real-time voice receiving device in real-time voice communication.

Further to any one of the embodiments above of the device, optionally the re-sampling module configured to monitor the amount of data in the input buffer area of the re-sampling module is configured:

To determine that an input buffer area of the succeeding stage of processing module operating in a non-blocking mode is full, according to a full input buffer area indicator of the succeeding stage of processing module, and to monitor at least the amount of data in the input buffer area of the re-sampling module.

In an embodiment of the disclosure, the relevant functional modules can be embodied by a hardware processor.

Particular implementations of the operations performed by the respective modules in the device according to the embodiment above have been detailed in the embodiment of the method above, so a detailed description thereof will be omitted here.

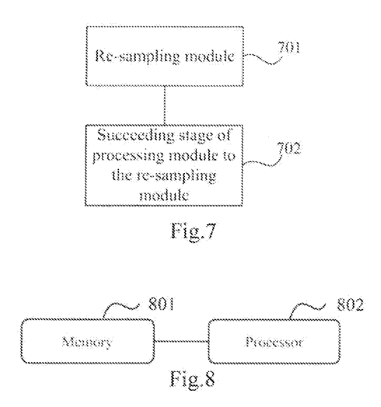

Based upon the same inventive idea, an embodiment of the disclosure timber provides an electronic device and as illustrated in FIG. 8, there is a schematic structural diagram of the device including at feast one processor 802; end a memory 801 communicable connected with the at least one processor for storing instructions executable by the at least one processor, wherein execution of the instructions in the at least one processor causes the at least one processor to:

monitor at least the amount of data in an input buffer area of a re-sampling module, wherein the data in the input buffer area of the re-sampling module are decompressed and de-packaged data;

re-sample the data, in the input buffer area of the re-sampling module if the monitored amount of data in the buffer area reaches a re-sampling threshold; and

perform a succeeding stage of processing on the re-sampled data.

In some embodiments, execution of the instructions by the at least one processor causes the at least one processor to: re-sample the data in the input buffer area of the re-sampling module by a re-sampling ratio preset corresponding to the re-sampling threshold, wherein each re-sampling threshold corresponds to at least one re-sampling ratio.

In some embodiments, execution of the instructions by the at least one processor causes the at least one processor to:

monitor only the amount of data in the input buffer area of the re-sampling module; or

monitor both the amount of data in the input buffer area of the re-sampling module, and the amount of data in an input buffer area of a succeeding stage of processing module.

In some embodiments, the size of the input buffer area of the re-sampling module is determined by audio processing parameters of the real-time voice receiving device in real-time voice communication.

In some embodiments, execution of the instructions by the at least one processor causes the at least one processor to:

determine that an input buffer area of a succeeding stage of processing module operating in a non-blocking mode is full, according to a full input buffer area indicator of the succeeding stage of processing module, and monitor at least the amount of data in the input buffer area of the re-sampling module.

In some embodiments, execution of the instructions by the at least one processor causes the at least one processor to:

perform digital to analog-decoding on the re-sampled data.

Moreover an embodiment of the disclosure further provides a non-transitory computer readable storage medium storing executable instructions that, when executed by an electronic device, cause the electronic device to perform the method above as illustrated in FIG. 2.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for shortening a delay in real-time voice communication, applicable to a real-time voice receiving device, the method comprising:
monitoring at least the amount of data in an input buffer area of a re-sampling module, wherein the data In the input buffer area of the re-sampling module are decompressed and de-packaged data;
re-sampling the data In the input buffer area of the re-sampling module if the monitored amount of data in the buffer area reaches a re-sampling threshold; and
performing a succeeding stage of processing on the re-sampled data.

2. The method according to claim 1, wherein re-sampling the data in the input buffer area of the re-sampling module comprises:
re-sampling the data in the input buffer area of the re-sampling module by a re-sampling ratio preset corresponding to the re-sampling threshold, wherein each re-sampling threshold corresponds to at least one re-sampling ratio.

3. The method according to claim 1, wherein monitoring at least the amount of data in the input buffer area of the re-sampling module comprises:
monitoring only the amount of data in the input buffer area of the re-sampling module; or
monitoring both the amount of data in the Input buffer area of the re-sampling module, and the amount of data in an input buffer area of a succeeding stage of processing module.

4. The method according to claims 1, wherein the size of the input buffer area of the re-sampling module is determined by audio processing parameters of the real-time voice receiving device in real-time voice communication.

5. The method according to claim 1, wherein monitoring at least the amount of data in the input buffer area of the re-sampling module comprises:
determining that an input buffer area of a succeeding stage of processing module operating in a non-blocking mode is full, according to a full input buffer area indicator of the succeeding stage of processing module, and monitoring at least the amount of data in the input buffer area of the re-sampling module.

6. The method according to claim 1, wherein performing the succeeding stage of processing on the re-sampled data comprises:
performing digital to analog-decoding on the re-sampled data.

7. An electronic device, comprising:
at least one processor; and
a memory communicably connected with the at least one processor for storing instructions executable by the at least one processor, wherein execution of the instructions fey the at least one processor causes the at least one processor to:
monitor at least the amount of data in an input buffer area of a re-sampling module, wherein the data in the input buffer area of the re-sampling module are decompressed and de-packaged data;
re-sample the data in the input buffer area of the re-sampling module if the monitored amount of data in the buffer area reaches a re-sampling threshold; and
perform a succeeding stage of processing on the re-sampled data.

8. The electronic device according to claim 7, wherein execution of the instructions by the at least one processor causes the at least one processor to: re-sample the data in the input buffer area of the re-sampling module by a re-sampling ratio preset corresponding to the re-sampling threshold, wherein each re-sampling threshold corresponds to at least one re-sampling ratio.

9. The electronic device according to claim 7, wherein execution, of the instructions by the at least one processor causes the at least one processor to:
monitor only the amount of data in the input buffer area of the re-sampling module; or
monitor both the amount of data in the input buffer area of the re-sampling module, and the amount of data in an Input buffer area of a succeeding stage of processing module.

10. The electronic device according to claim 7, wherein the size of the input buffer area of the re-sampling module is determined by audio processing parameters of the real-time voice receiving device in real-time voice communication.

11. The electronic device according to claim 7, wherein execution of the instructions by the at least one processor causes the at least one processor to:
determine that an input buffer area of a succeeding stage of processing module operating in a non-blocking mode is full, according to a full input buffer area indicator of the succeeding stage of processing module, and monitor at least the amount of data in the input buffer area of the re-sampling module.

12. The electronic device according to claim 7, wherein execution of the instructions by the at least one processor causes the at least one processor to:
perform digital to analog-decoding on there-sampled data.

13. A non-transitory computer-readable storage medium storing executable instructions that, when executed by an electronic device, cause the electronic device to:
monitor at least the amount of data in an input buffer area of a re-sampling module, wherein the data in the input buffer area of the re-sampling module are decompressed and de-packaged data;
re-sample the data In the input buffer area of the re-sampling module if the monitored amount of data in the buffer area reaches a re-sampling threshold; and
perform a succeeding stage of processing on the re-sampled data.

14. The non-transitory computer-readable storage medium according to claim 13, wherein the executable instructions cause the electronic device to: re-sample the data in the input buffer area of the re-sampling module by a re-sampling ratio preset corresponding to the re-sampling threshold, wherein each re-sampling threshold corresponds to at least one re-sampling ratio.

15. The non-transitory computer-readable storage medium according to claim 13, wherein the executable instructions cause the electronic device to:
monitor only the amount of data in the input buffer area of the re-sampling module; or
monitor both the amount of data in the input buffer area of the re-sampling module, and the amount of data in an input buffer area of a succeeding stage of processing module.

16. The non-transitory computer-readable storage medium according to claim 13, wherein the size of the input buffer area of the re-sampling module is determined by audio processing parameters of the real-time voice receiving device in real-time voice communication.

17. The non-transitory computer-readable storage medium according to claim 13, wherein the executable instructions cause the electronic device to:
determine that an input buffer area of a succeeding stage of processing module operating in a non-blocking mode is full, according to a full input buffer area indicator of the succeeding stage of processing module, and monitor at least the amount of data in the input buffer area of the re-sampling module.

18. The non-transitory computer-readable storage medium according to claim 12, wherein the executable Instructions cause the electronic device to:
perform digital to analog-decoding on the re-sampled data.
